(19) United States
(12) Patent Application Publication
(10) Pub. No.: US 2015/0199428 A1
(43) Pub. Date: Jul. 16, 2015

(54) METHODS AND SYSTEMS FOR ENHANCED VISUAL CONTENT DATABASE RETRIEVAL

(71) Applicant: UTC FIRE & SECURITY AMERICAS CORPORATION, INC., Bradenton, FL (US)

(72) Inventors: Zhen Jia, Shanghai (CN); Jianwei Zhao, Shanghai (CN)

(21) Appl. No.: 14/420,019

(22) PCT Filed: Aug. 7, 2013
(86) PCT No.: PCT/US2013/053937

§ 371 Date: Feb. 6, 2015

(30) Foreign Application Priority Data
Aug. 8, 2012 (CN) 201210280182.3

(51) Int. Cl. G06F 17/30

(52) U.S. Cl. CPC G06F 17/30858; G06F 17/30262

(57) ABSTRACT

Methods and systems are provided for performing visual search and retrieval by combining low-level and high-level visual features derived from visual content, and then indexing the combined visual features or searching for similar visual content using the combined visual features. A visual content retrieval system converts low-level and high-level visual features of a query video into low-level and high-level visual descriptors of the query video, respectively. The visual content retrieval system combines the low-level and high-level visual descriptors of the query video into combined visual descriptors, and then searches for and retrieves one or more similar videos in a video database using the combined visual descriptors of the query video.

### FIELD

The present teachings relate generally to methods and systems for enhancing visual content database retrieval, and more particularly, to platforms and techniques for performing visual search and retrieval by first combining various visual features derived from visual content, and then searching for similar visual content using the combined visual features and/or indexing the combined visual features.

### BACKGROUND

Typically, when image/video search and retrieval are conducted, low-level visual features are used. For instance, color histogram is used to compare the similarity between a query image/video with videos in a database. Recently, researchers have begun to pay greater attention to image/video retrieval using high-level visual features, such as retrieval based on visual concepts in an image/video.

However, there are limitations with using either low-level or high-level visual features to retrieve images/videos. For instance, low-level visual features do not take image content into consideration, and results retrieved using low-level visual features may simply reflect visual similarity but not be meaningful. Using high-level visual features to retrieve images/videos may also return poor results because of sensitivities of high-level visual features extraction.

### SUMMARY

According to the present teachings in one or more aspects, methods and systems for enhancing visual content database retrieval are provided, in which a visual content retrieval system performs visual search and content retrieval by combining low-level and high-level visual features derived from visual content, and then searches for and retrieves similar visual content using the combined visual features and/or indexes the combined visual features. In general implementations of the present teachings, the visual content retrieval system can combine low-level and high-level visual descriptors of a query video into combined visual descriptors, and can then search for and retrieve one or more similar videos in a video database using the combined visual descriptors of the query video.

### DESCRIPTION OF THE DRAWINGS

The accompanying drawings, which are incorporated in and constitute a part of this specification, illustrate aspects of the present teachings and together with the description, serve to explain principles of the present teachings. In the figures:

FIG. l illustrates an exemplary visual content retrieval system that performs visual searching and retrieval by combining low-level and high-level visual features derived from visual content, and then searching for similar visual content using the combined visual features and/or indexing the combined visual features, consistent with various embodiments of the present teachings;

FIG. 2 illustrates a flowchart of processing performed by the visual content retrieval system to provide enhanced visual searching and retrieval, according to various embodiments of the present teachings; and

FIG. 3 illustrates a computer system that is consistent with embodiments of the present teachings.

### DETAILED DESCRIPTION

Reference will now be made in detail to various embodiments of the present teachings, an example of which is illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific implementations in which may be practiced. These implementations are described in sufficient detail to enable those skilled in the art to practice these implementations and it is to be understood that other implementations may be utilized and that modifications and equivalents may be made without departing from the scope of the present teachings. The following description is, therefore, merely exemplary.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Aspects of the present teachings relate to systems and methods for enhancing visual content database retrieval. More particularly, in various aspects, and as for example generally shown in FIG. 1, platforms and techniques are provided in which a visual content retrieval system 100 can perform visual searching and retrieval by combining low-level and high-level visual features derived from visual content, and then search for similar visual content using the combined visual features and/or index the combined visual features. In doing so, visual content retrieval system 100 can perform, without training, efficient and robust visual searches and retrieval of highly relevant visual content. Visual content can include, for example, one or more videos, one or more images, and the like. Low-level visual features can include, for example, visual content's colors, textures, edges, contours, and the like. High-level visual features can include, for example, events, visual concepts, semantic contents, and other high-level visual features contained in the visual content, such as movement, shadows, change in shadows, illumination, change in illumination, busy levels, change in busy levels, shakiness levels, change in shakiness levels, and the like.

According to various embodiments, and as generally shown in FIG. 1, visual content retrieval system 100 can use an image processor 110 to extract low-level and high-level visual features from visual content in a video database 120, combine low-level and high-level visual descriptors derived from the low-level and high-level visual features, and store and index the combined visual descriptors in a video features database 130, which can be used by visual content retrieval system 100 to search for and retrieve the visual content in video database 120 in the future. Visual content retrieval system 100 can also use image processor 110 to extract low-level and high-level visual features from a query video 150 and combine low-level and high-level visual descriptors derived from the low-level and high-level visual features into query video features 160, and then use visual content retriever 170 to search for and retrieve similar visual content from video database 120, such as one or more nearest neighboring videos in video database 120. For example, visual content retriever 170 can perform a histogram similarity measure between query video features 160 and combined visual descriptors in video features database 130, such as a variable bin size distance technique, to search for or locate videos in video database 120 that are the most similar to query video 150. Visual content retrieval system 100 can also store and index query video features 160 in video features database 130, which can be used by visual content retrieval system 100 to search for and retrieve the query video in video database 120 in the future.

Image processor 110 can process videos in video database 120 and populate video features database 130 offline, i.e., when not searching for nearest neighboring videos for query video 150, and thus improving turnaround time when searching for the nearest neighboring videos. Although FIG. 1 shows image processor 110 as singular or integrated, image processor 100 can be plural or distributed. According to various embodiments, image processor 110 can execute in a single process, in multiple independent or interconnected processes on a single machine, or in multiple independent or interconnected processes on multiple machines. More particularly, as shown in FIG. 1, image processor 110 can include a low-level visual features extractor 112, a high-level visual features extractor 114, and a descriptor mixer 116. Low-level visual features extractor 112 can extract low-level features from visual content and generate one or more low-level visual descriptors, such as one or more histograms (e.g., a color histogram) of the low-level features. High-level visual features extractor 114 can extract high-level features from the visual content and generate high-level visual descriptors, such as one or more histograms to represent values for the high-level features. For example, high-level visual features extractor 114 can assign different values to different bins of a histogram for a high-level visual feature. Descriptor mixer 116 can combine or fuse/mix the low-level and high-level visual descriptors into combined visual descriptors. For example, descriptor mixer 116 can use a combination technique to combine or fuse/mix the low-level and high-level visual descriptors. Combination techniques can include, for example, weighted histogram, decision fusion, selective filtering, and the like.

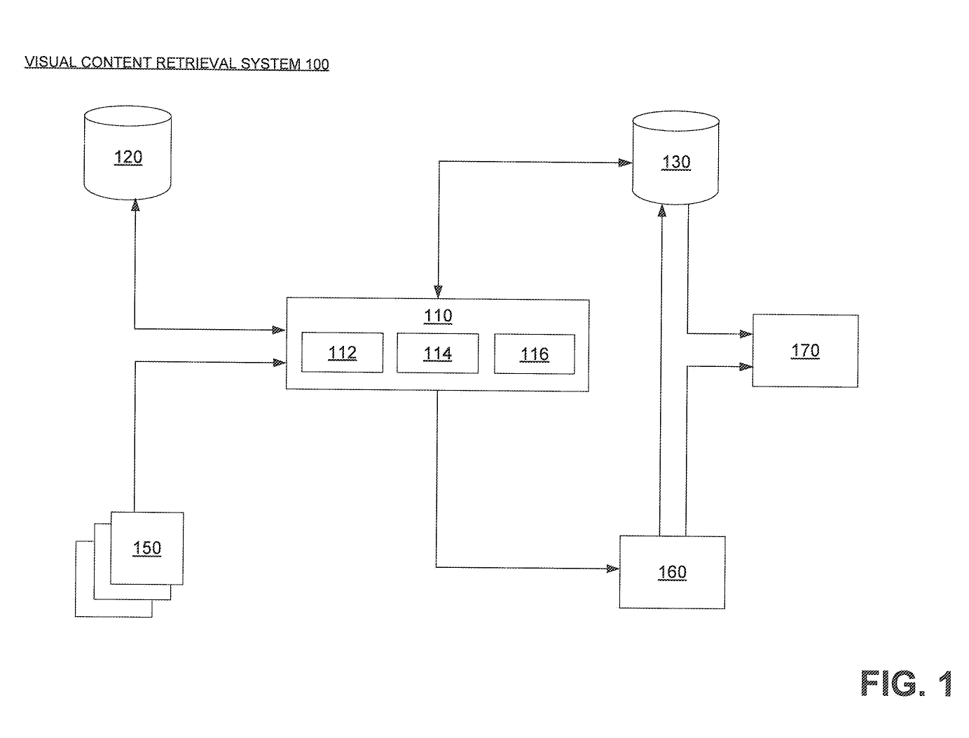

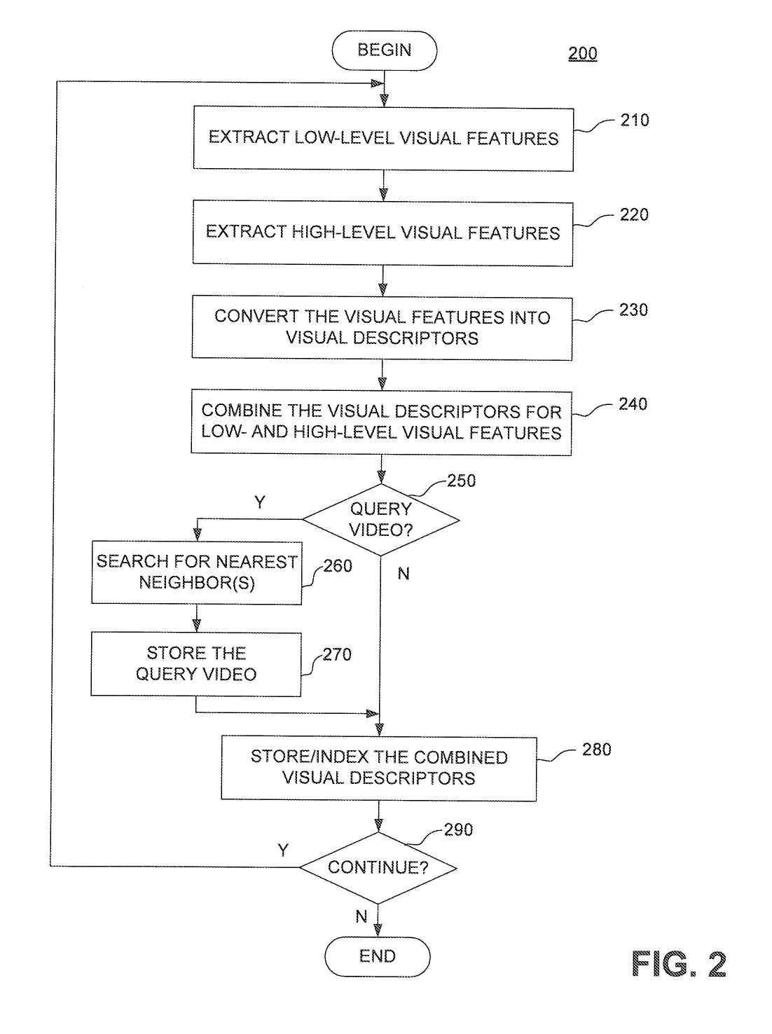

FIG. 2 illustrates methodologies and/or flow diagrams of processing 200 performed by visual content retrieval system 100 to provide enhanced visual searching and retrieval, according to various embodiments of the present teachings. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

As shown in FIG. 2, in 210, visual content retrieval system 100 can use image processor 110 to extract low-level features from visual content (e.g., a video in video database 120 or query video 150). Next, in 220, visual content retrieval system 100 can use image processor 110 to extract high-level features from the visual content. Then, in 230, visual content retrieval system 100 can use image processor 110 to convert the low-level and high-level features into low-level and high-level visual descriptors, respectively. In 240, visual content retrieval system 100 can use image processor 110 to combine, fuse, or mix the low-level and high-level visual descriptors into combined visual descriptors of the visual content.

Subsequently, in 250, visual content retrieval system 100 can determine whether the visual content is a query video (e.g., query video 150) or not (e.g., a video in video database 120). If the visual content is determined to not be a query video, then processing 200 can proceed directly to 280. Alternatively, if in 250 the visual content is determined to be a query video, then in 260 visual content retrieval system 100 can use image visual content retriever 170 to search for and provide one or more nearest neighboring videos for the query video based on the combined visual descriptors. Next, in 270, visual content retrieval system 100 can store the query video in video database 120 for future retrieval.

In 280, visual content retrieval system 100 can store and/or index the combined visual descriptors of the visual content in video features database 130, which can then be used by visual content retrieval system 100 to search for and retrieve the visual content in the future. Finally, in 290, visual content retrieval system 100 can determine whether or not to continue processing 200. If yes, then processing 200 returns to 210; if no, then processing 200 ends.

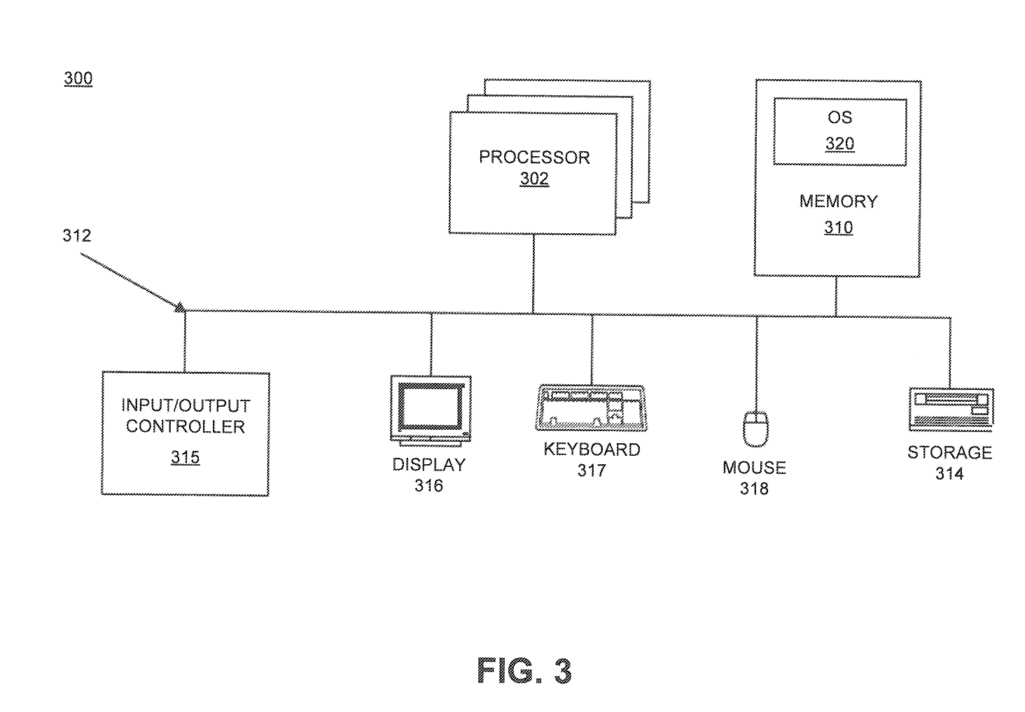

FIG. 3 illustrates a computer system 300 that is consistent with embodiments of the present teachings. In general, embodiments of visual content retrieval system 100 may be implemented in various computer systems, such as a personal computer, a server, a workstation, an embedded system, or a combination thereof, for example, system 300. Certain embodiments of visual content retrieval system 100 may be embedded as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. However, for purposes of explanation, system 300 is shown as a general purpose computer that is well known to those skilled in the art. Examples of the components that may be included in system 300 will now be described.

As shown, system 300 may include at least one processor 302, a keyboard 317, a pointing device 318 (e.g., a mouse, a touchpad, and the like), a display 316, main memory 310, an input/output controller 315, and a storage device 314. Storage device 314 can comprise, for example, RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. A copy of the computer program embodiment of visual content retrieval system 100 can be stored on, for example, storage device 314. System 300 may also be provided with additional input/output devices, such as a printer (not shown). The various components of system 300 communicate through a system bus 312 or similar architecture. In addition, system 300 may include an operating system (OS) 320 that resides in memory 310 during operation. One skilled in the art will recognize that system 300 may include multiple processors 302. For example, system 300 may include multiple copies of the same processor. Alternatively, system 300 may include a heterogeneous mix of various types of processors. For example, system 300 may use one processor as a primary processor and other processors as co-processors. For another example, system 300 may include one or more multi-core processors and one or more single core processors. Thus, system 300 may include any number of execution cores across a set of processors (e.g., processor 302). As to keyboard 317, pointing device 318, and display 316, these components may be implemented using components that are well known to those skilled in the art. One skilled in the art will also recognize that other components and peripherals may be included in system 300.

Main memory 310 serves as a primary storage area of system 300 and holds data that is actively used by applications, such as visual content retrieval system 100, running on processor 302. One skilled in the art will recognize that applications are software programs that each contains a set of computer instructions for instructing system 300 to perform a set of specific tasks during runtime, and that the term “applications” may be used interchangeably with application software, application programs, and/or programs in accordance with embodiments of the present teachings. Memory 310 may be implemented as a random access memory or other forms of memory as described below, which are well known to those skilled in the art.

OS 320 is an integrated collection of routines and instructions that are responsible for the direct control and management of hardware in system 300 and system operations. Additionally, OS 320 provides a foundation upon which to run application software. For example, OS 320 may perform services, such as resource allocation, scheduling, input/output control, and memory management. OS 320 may be predominantly software, but may also contain partial or complete hardware implementations and firmware. Well known examples of operating systems that are consistent with the principles of the present teachings include MICROSOFT WINDOWS (e.g., WINDOWS CE, WINDOWS NT, WINDOWS 2000, WINDOWS XP, and WINDOWS VISTA), MAC OS, LINUX, UNIX, ORACLE SOLARIS, OPEN VMS, and IBM AIX.

The foregoing description is illustrative, and variations in configuration and implementation may occur to persons skilled in the art. For instance, the various illustrative logics, logical blocks, modules, and circuits described in connection with the embodiments disclosed herein may be implemented or performed with a general purpose processor (e.g., processor 302), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

If implemented in software, the functions may be stored on or transmitted over a computer-readable medium as one or more instructions or code. Computer-readable media includes both tangible computer storage media and communication media including any medium that facilitates transfer of a computer program from one place to another. A storage media may be any available tangible media that can be accessed by a computer. By way of example, and not limitation, such tangible computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Resources described as singular or integrated can in one embodiment be plural or distributed, and resources described as multiple or distributed can in embodiments be combined. The scope of the present teachings is accordingly intended to be limited only by the following claims, and modifications and equivalents may be made to the features of the claims without departing from the scope of the present teachings.

What is claimed is:

1. A method for enhancing video retrieval, comprising:
combining low-level visual descriptors and high-level visual descriptors of a query video into combined visual descriptors of the query video;
searching for and retrieving one or more similar videos in a video database based on the combined visual descriptors of the query video; and
providing the one or more similar videos.

2. The method of claim, wherein searching for and retrieving one or more similar videos further comprises:
comparing the combined visual descriptors of the query video to combined visual descriptors of a first video in the video database, wherein the combined visual descriptors of the first video includes a combination of low-level visual descriptors and high-level visual descriptors of the first video.

3. The method of claim 2, wherein high-level visual features of the query video include at least one of an event, a visual concept, or semantic content.

4. The method of claim 2, wherein combining the low-level visual descriptors and the high-level visual descriptors of the query video further comprises:
combining the low-level visual descriptors and the high-level visual descriptors of the query video into the combined visual descriptors of the query video based on a combination technique used to combine the low-level visual descriptors and the high-level visual descriptors of the first video into the combined visual descriptors of the first video.

5. The method of claim 2, further comprising:
extracting low-level visual features and high-level visual features of the query video based on an extraction technique used to extract low-level visual features and high-level visual features of the first video.

6. The method of claim 5, further comprising:
converting the high-level visual features of the query video into the high-level visual descriptors of the query video based on a conversion technique used to convert high-level visual features of the first video into the high-level visual descriptors of the first video.

5. The method of claim 5, further comprising:
converting the low-level visual features of the query video into the low-level visual descriptors of the query video based on a conversion technique used to convert low-level visual features of the first video into the low-level visual descriptors of the first video.

8. The method of claim 1, further comprising:
storing the query video in the video database.

9. The method of claim 1, further comprising:
indexing the combined visual descriptors of the query video.

10. A method for retrieving videos from a video database, wherein the videos are indexed based on combined visual descriptors of the videos that include a combination of low-level visual descriptors and high-level visual descriptors of the videos, the method comprising:
combining low-level visual descriptors and high-level visual descriptors of a query video into combined visual descriptors of the query video based on a combination technique used to combine the low-level visual descriptors and the high-level visual descriptors of the videos into the combined visual descriptors of the videos;
searching for and retrieving one or more similar videos in the video database based on the combined visual descriptors of the query video and one or more combined visual descriptors of the one or more similar videos; and
providing the one or more similar videos.

11. A system for performing video retrieval, comprising:
a descriptor mixer configured to combine low-level visual descriptors and high-level visual descriptors of a query video into combined visual descriptors of the query video;
a content retriever configured to search for and retrieve one or more similar videos in a video database based on the combined visual descriptors of the query video; and
a server configured to provide the one or more similar videos.
